(19) United States
(12) Patent Application Publication
(10) Pub. No.: US 2011/0307316 A1
(43) Pub. Date: Dec. 15, 2011

(54) METHOD FOR TRACKING FOOD PRODUCT EXPIRATION AND INITIATING SALES PROMOTIONS USING A FOOD PRODUCT SCALE

(76) Inventors: Timothy B. Peters, Troy, OH (US); James C. Meyer, Troy, OH (US)

(21) Appl. No.: 12/797,038

(22) Filed: Jun. 9, 2010

(51) Int. Cl. G06Q 30/00; G06Q 10/00; G06F 17/30; G06Q 50/00

(52) U.S. Cl. 705/14.24; 707/802; 707/E17.044

(57) ABSTRACT

A method of selectively and timely promoting sale of a specific food product using a food product scale is provided, where the food product scale includes a weighing station including an associated mechanism for producing weight indicative signals, and a customer facing display is associated with the scale. The method involves entering product identification information of a specific food product into the food product scale using an operator interface of the food product scale; identifying an initial quantity of the specific food product; identifying expiration data for the specific food product; creating a shelf life record that is saved in memory, the shelf life record including the product identification information, the expiration data of the specific food product and the initial quantity; tracking subsequent transactions for the specific food product and quantity of each subsequent transaction; based upon the tracking step, automatically and selectively implementing a sales promotion for the specific food product when sales promotion criteria are met, the sales promotion criteria based at least in part upon remaining quantity of the specific food product; and when the sales promotion is implemented, displaying a sales promotional message on the customer facing display to notify customers of the sales promotion, the sales promotional message identifying both the specific food product and promotional price information for the specific food product.

### TECHNICAL FIELD

The present application relates generally to scales used to weigh food products in supermarkets, and more particularly to a system and method for tracking food products using a scale and automatically and selectively implementing sales promotions for certain food products.

### BACKGROUND

Scales have been used in stores such as supermarkets and groceries to weigh and price food items and to generate a pricing label for such food items. A typical store includes multiple scales located in multiple perishables departments. It is important that weighed items be priced properly and therefore scales are commonly connected into a store network so that the latest pricing information can be provided to the scales in a timely manner. It is also important to reduce discard or waste of food products that can occur for multiple reasons, such as expiration of product shelf life.

### SUMMARY

In an aspect, a method of selectively and timely promoting sale of a specific food product using a food product scale is provided, where the food product scale includes a weighing station including an associated mechanism for producing weight indicative signals, and a customer facing display is associated with the scale. The method involves entering product identification information of a specific food product into the food product scale using an operator interface of the food product scale; identifying an initial quantity of the specific food product; identifying expiration data for the specific food product; creating a shelf life record that is saved in memory, the shelf life record including the product identification information, the expiration data of the specific food product and the initial quantity; tracking subsequent transactions for the specific food product and quantity of each subsequent transaction; based upon the tracking step, automatically and selectively implementing a sales promotion for the specific food product when sales promotion criteria are met, the sales promotion criteria based at least in part upon remaining quantity of the specific food product; and when the sales promotion is implemented, displaying a sales promotional message on the customer facing display to notify customers of the sales promotion, the sales promotional message identifying both the specific food product and promotional price information for the specific food product.

In another aspect, a method of selectively and timely promoting sale of a specific food product using a food product scale is provided, where the food product scale includes a weighing station including an associated mechanism for producing weight indicative signals, and a customer facing display is associated with the scale. The method involves creating and saving in memory a shelf life record for the specific food product, the shelf life record including product identification information for the specific food product, expiration data for the specific food product and initial quantity for the specific food product; tracking subsequent transactions for the specific food product and quantity of each subsequent transaction; and based upon the tracking step, automatically and selectively implementing a sales promotion for the specific food product when first sales promotion criteria are met, the first sales promotion criteria based at least in part upon remaining quantity of the specific food product, when the sales promotion is implemented, displaying a first sales promotional message on the customer facing display to notify customers of the first sales promotion, the first sales promotional message identifying both the specific food product and a first promotional price for the specific food product, and subsequently altering the sales promotion to further reduce price for the specific food product when second sales promotion criteria are met and thereafter displaying a second sales promotional message on the customer facing display, the second sales promotional message identifying both the specific food product and a second promotional price for the specific food product, the second promotional price lower than the first promotional price.

In still a further aspect, a method of selectively and timely promoting sale of a specific food product using a food product scale is provided, where the food product scale includes a weighing station including an associated mechanism for producing weight indicative signals, and a customer facing display is associated with the scale. The method involves: for each of a plurality of food products, creating and saving in memory a corresponding shelf life record including product identification information, expiration data and initial quantity; automatically tracking subsequent transactions for the multiple food products, including quantity of each subsequent transaction; and based upon the tracking step, automatically identifying impending expiration of at least one food product and automatically implementing a sales promotion for the identified food product, implementation of the sales promotion involves displaying a sales promotional message on the customer facing display to notify customers of the sales promotion, the sales promotional message identifying both the identified food product and a promotional price for the identified food product.

Other advantages and features of the invention will be apparent from the following description of particular embodiments and from the claims.

### BRIEF DESCRIPTION OF THE DRAWINGS

FIG. 1 is a perspective view of an embodiment of a food product scale;

FIGS. 2 and 3 show and alternative embodiment of a food product scale including a second customer facing display;

FIG. 4 is a schematic illustration of the food product scale of FIG. 2;

FIG. 5 is a schematic diagram of an embodiment of a store including multiple departments and multiple scales;

FIG. 6 is an embodiment of a scale user interface screen;

FIG. 7 illustrates an embodiment of a shelf life label;

FIG. 8 is an embodiment of flow diagram for synchronizing scales; and

FIG. 9 is an embodiment of a sale promotion identification routine.

### DETAILED DESCRIPTION

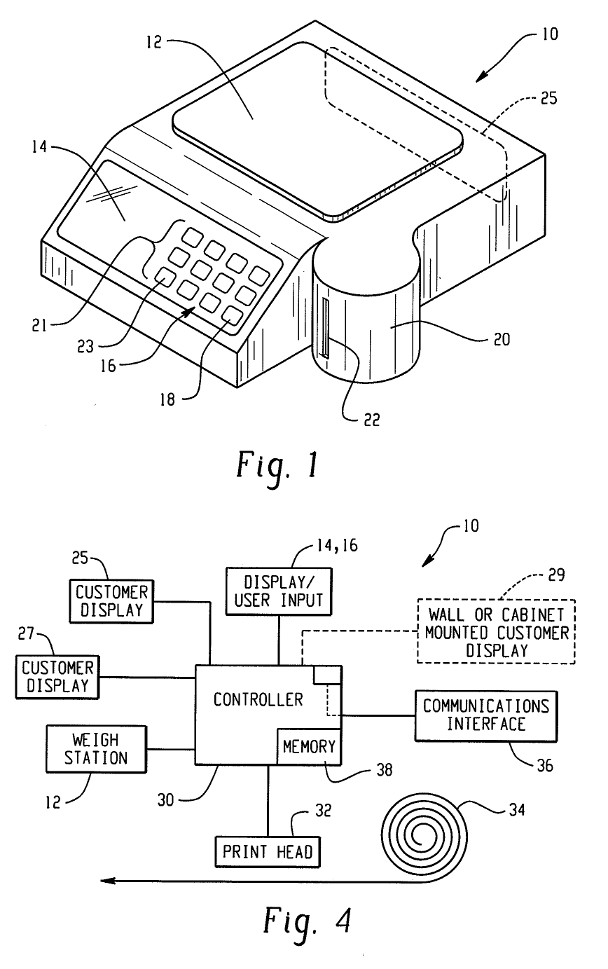

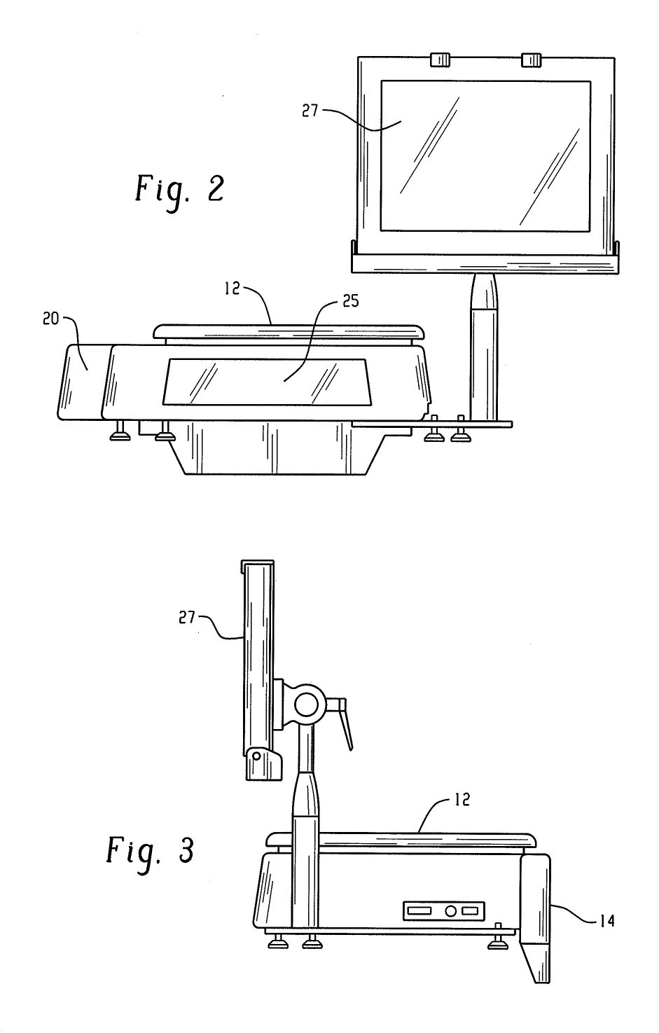

Referring to FIG. 1 an exemplary scale 10 is shown including a weigh station 12 and a display 14. Weigh station 12 may take the form of a platter-type member supported in relationship to a load cell (internal of the scale housing) that produces a weight indicative signal when a food item is placed on the weigh station 12 for weighing. Illustrated display 14 may take the form of an LCD-type display, but other technologies could be used. In the illustrated embodiment the display 14 is a touch screen-type display that also functions as a user input device 16 by displaying image buttons/icons 18 that can be triggered or selected by an operator. The buttons/icons 18 allow for user selection of an item to be weighed from a menu or group 21 of items 23 presented to the user by display 14. In one variation, the group 21 may be a numeric keypad allowing manual entry of product numbers. In another variation, the group 21 may be images of specific products that might be weighed by the scale. A separate operator input device could also be provided, for example, in the form of manually activated keys/buttons located alongside the display 14. A side portion 20 of the scale housing holds a label printer and associated supply of labels, which are dispensed through a label slot 22 in the housing. A customer facing display 25 is provided for communicating information to customers (e.g., weight and price of a product being weighed). Although display screens 14 and 25 are shown incorporated into the housing of the scale 10, the displays could take the form of marquee-type displays located on a support extending upward from the scale housing. By way of example, referring to FIGS. 2 and 3, a scale embodiment including a second customer facing display 27 is shown. In this instance customer facing display 25 may be used for typical display of weight and price data and the customer facing display 27 may be used for display the sales promotion messages described below. In some implementations (e.g., a scale weigh and label system associated with a package wrapping machine for prepack), the display need not be attached to the scale/printer via a support but could be a separately housed console or display screen that is associated with the scale/printer by being logically attached, either directly or indirectly, to the scale/printer (e.g., per the wall or cabinet mounted customer display 29 shown schematically in FIG. 4).

Referring now to FIG. 4, an exemplary schematic of the scale 10 is shown. The scale includes a controller 30, such as a microprocessor based unit, connected to control the operator display/user input 14, 16 and customer facing displays 25 and 27. The control is also connected to receive weight indicative signals from the weighing station 12. A print head 32 and associated supply of label stock 34 that can be moved past the print head 32 is also shown. In one example the print head 32 may be a thermal print head for use with thermally activated label stock. However, other types of printing technologies and label media could also be used. The controller 30 is also connected with a communications interface 36, which may take the form of a standard connector (and associated circuitry) for a USB, RS-232, Ethernet or other hard-wired communication line. In another example the communications interface 36 may be formed by a wireless communication device such as an RF transceiver. The communications interface 36 may communicate with other scales over the network. The network may also provide Internet connection. The illustrated controller 30 includes associated memory 38 for storing product information (e.g., product names, characteristics and pricing stored in association with corresponding product numbers).

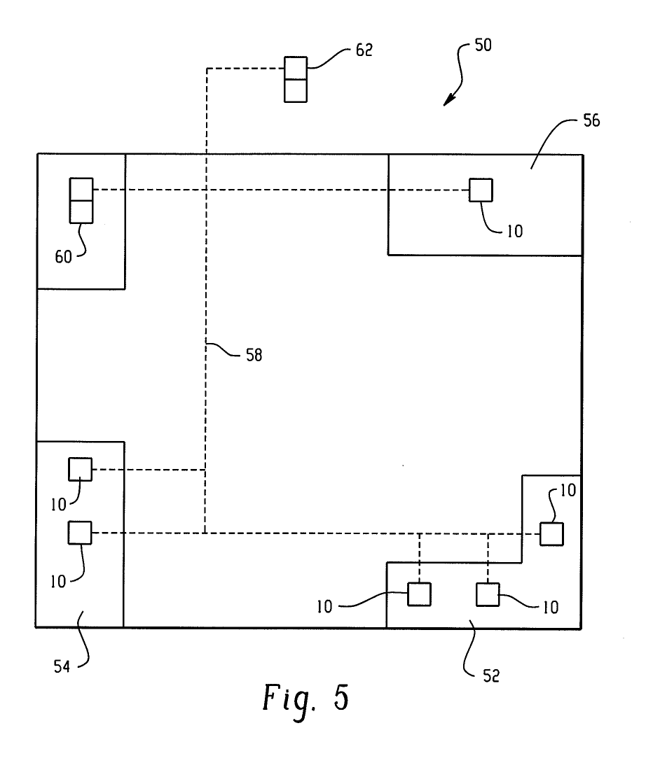

Referring also to FIG. 5, an exemplary store plan 50 is shown with multiple scales 10 in various store perishables departments 52, 54 and 56 (e.g., such as the deli department, the meat and fish department, the bakery department and/or the fruit and vegetable departments), each scale connected to a network 58 for communicating with one of the other scales 10 and/or for communicating with a store computer, which may be located in the store as indicated by computer 60 or at a site remote from the store as indicated by computer 62. In a typical store application, each scale receives update data (e.g., price changes, etc.) via the network connection so that the scales are capable of labeling, pricing, tracking, etc. products accurately. The scales may receive the update data directly from a store computer 60 or 62, typically utilizing some commercially available scale management software.

In the inventive system of the present application the scales 10 are used to track product sales and implement sales promotions for food products that are at risk of expiring before the entire quantity of the food product is sold. In one exemplary application, an item to be cut-down or sliced, such as a block of cheese, loaf of turkey or ham is located in the deli department. Once the item is opened, it is desirable to track the expiration and/or any discards of the loaf of turkey or ham including any items derived from the loaf and placed on the shelf for purchase. The scales 10 are used to track the expiration date of the item and transactions involving the item (e.g., each filled customer order for the item and the quantity of the order). This tracking enables a remaining quantity of the item to be determined and tracked (e.g., either within the scale itself or using the store computer that receives transaction data from the scales). An automated determination can then be made (e.g., by the scale or store computer) to implement a promotional sale for the item if the item is at risk of expiring. As used herein, the term “expiration date” or “expiration data” can also include an expiration time of day.

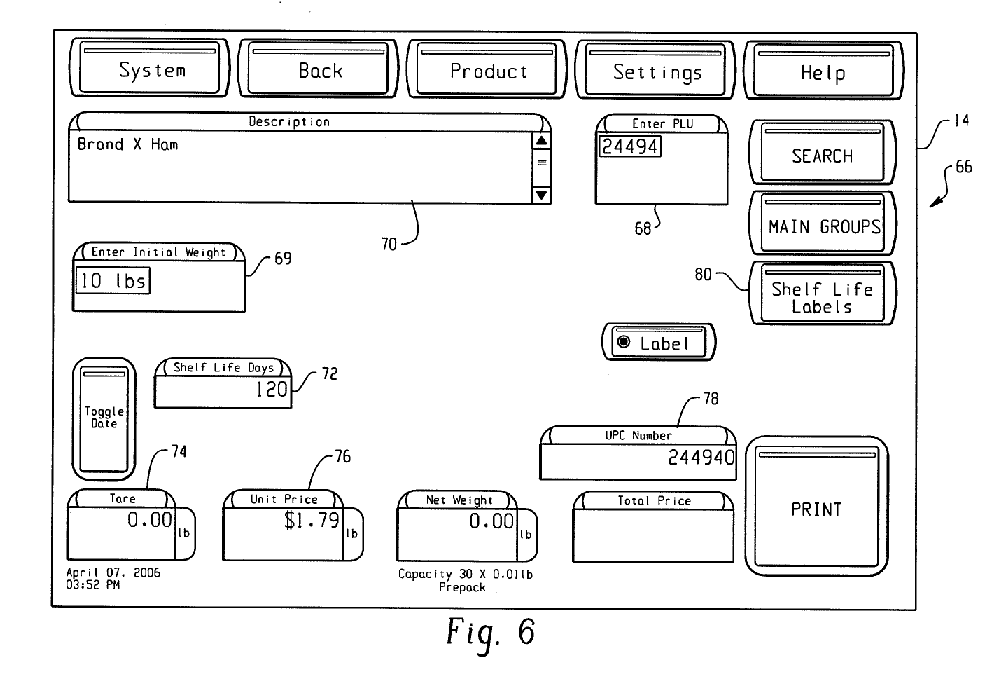

Referring now to FIG. 6, the operator displays 14 of the scales 10 include a user input screen 66. FIG. 4 is an exemplary user input screen and there may be other user input screens in addition to user input screen 66. The user input screen 66 includes an Enter PLU field 68 for use in entering a product look-up code (or other product identification information), an Enter Initial Quantity field 69 for entering the initial weight or count of the food product (e.g., the initial weight of a newly opened loaf of ham or the number of a newly made-up food item such as twice-baked potatoes) and a Description field 70 for displaying a product description corresponding to the product look-up code. A Shelf Life Days field 72 displays a number of days that the product associated with the product identification information can be placed on the shelf for purchase. Other product information fields include a Tare field 74 for entering packaging weight, a Unit Price field 76 that displays a unit price associated with the product identification information and a UPC Number field 78 that displays the Universal Product Code for that product.

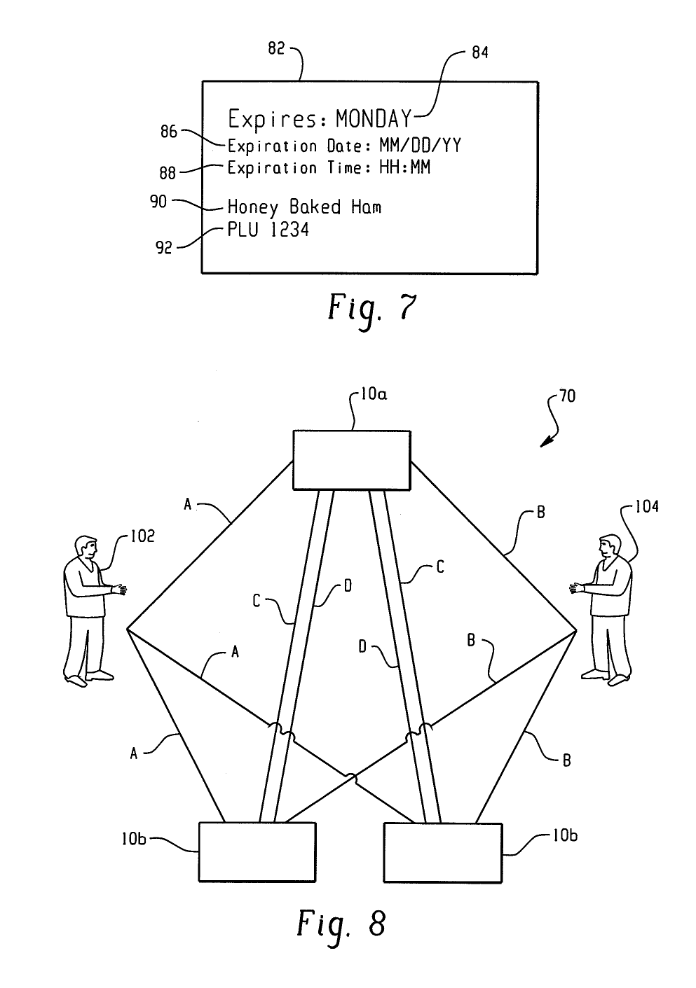

The number of days displayed in the Shelf Life Days field 72 can be a pre-set value retrieved from memory and associated with the PLU. The number of days displayed in the Shelf Life Days field 72 may also be selectable by the operator. Likewise, the initial quantity may in some cases be a pre-set quantity and in other cases may be selectable or otherwise enterable by the operator. Once the number of days displayed in the Shelf Life Days field 72 and the quantity in the Initial Quantity field are acceptable to the operator, a Shelf Life Label button 80 is actuated and a shelf life label 82 is printed. As shown in FIG. 7 the shelf life label 82 may include an expiration day of the week 84, an expiration date 86, an expiration time 88, an item description 90 and PLU 92. When the shelf life label 82 is printed, a shelf life record is created in memory of the scale 10 and/or memory of the store computer that will be used to track the item. The shelf life record will include the initial quantity data. The scales may thereafter be used to track transactions involving the item (e.g., customer orders for the food item or conversion/incorporation of the food item into a made-up item). For each transaction involving the food item, the quantity (e.g., weight or count) involved in the transaction is identified and the shelf life record for the food item is updated accordingly, By way of example, the initial quantity field in the shelf life record may be overwritten with a new quantity (e.g., a remaining quantity automatically determined by subtracting the transaction quantity from the quantity in the initial quantity field). Alternatively, the shelf life record may have a separate, Remaining Quantity field that gets updated after each transaction, while the Initial Quantity field remains the same.

Referring now to FIG. 8, an exemplary flow diagram 100 illustrates an approach for consolidating and distributing data, including the shelf life records. In the embodiment of FIG. 6, a primary scale 10a is responsible for consolidating and distributing update data pertaining to itself and one or more secondary scales 10b to another or other secondary scales 10b. Update data may be received from a number of sources. The shelf life records, a type of update data, are typically received by the primary scale 10a locally through an operator-initiated action at the primary scale or from a secondary scale where the shelf life label 82 is generated. Lines identified as A represent operator 102 interaction with a scale that causes changes to the scale's database. Lines identified as B represent updates from a location 104 remote from the scales, such as the store computer. Lines represented as C represent uploading of update data, such as self life records from the secondary scales 10b to the primary scale 10a. Lines represented as D represent the primary scale 10a synchronizing the secondary scales 10b with update data.

By default, a scale 10 may be configured as a primary scale or as a secondary scale. However, without a secondary scale 10b registered to a primary scale 10a, the primary scale may merely listen passively for update data and update its database when update data arrives. Similarly, a secondary scale 10b, without a primary scale 10a, may merely listen passively for update data and update its database when update data arrives. In some embodiments, an operator may change a scale from a primary scale to a secondary scale and vice versa using the user input device 16. In most embodiments, there is a single primary scale 10a for a group of secondary scales 10b. Typically, the secondary scale 10b maintains the primary scale's host name/IP address in order to communicate with the primary scale 10a over the network.

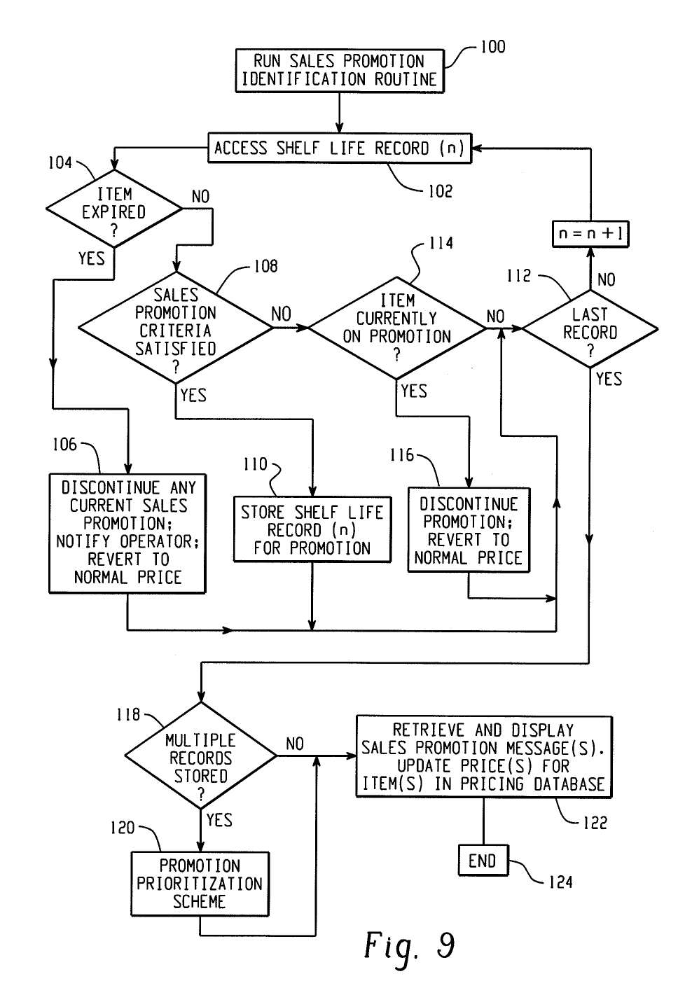

Referring now to FIG. 9, an exemplary sale promotion identification routine is shown. It is recognized that the various steps of the routine could be carried out by a scale, a store computer or the two devices in combination with each other. At step 100 the sales promotion routine is initiated (e.g., on a timed basis) and at step 102 a shelf life record of the shelf life record database is accessed. If the food item of the accessed shelf life record is identified as expired at step 104, then at step 106 any current sales promotion for the item is discontinued, the operator is notified of the expiration and the price for the item in the pricing database is returned to normal. If the item is not expired, then at step 108 a determination is made as to whether sales promotion criteria for the food item are satisfied. By way of example, the sales promotion criteria may be based at least in part upon both remaining quantity of the food product and the remaining shelf life of the food product (e.g., remaining quantity of the food product being above a set threshold and remaining shelf life of the food product being below a set threshold). Other criteria may also come into play, such as historical sales data for the food product (e.g., if it is 10 AM on a Wednesday and the product expires at 4 PM, historical sales data identifying what the anticipated sales are for Wednesday between 10 AM and 4 PM). If the sales promotion criteria are satisfied, the shelf life record is identified and stored for possible sales promotion at step 110 and the routine moves to step 112. If the sales promotion criteria are not satisfied, then at step 114 a determination is made whether the item is currently on sales promotion and, if so, at step 116 the sales promotion is discontinued and the price for the item is returned to the normal (e.g., non-sales promotion) price. At step 112, a determination is made as to whether all shelf life records have been considered and, if not, the routine returns to step 102 for consideration of the next record.

Once all shelf life records have been considered, at step 118 a determination is made as to whether multiple shelf life records have been identified for possible sales promotion. If so, then at step 120 a promotion prioritization scheme may be initiated to identify which of the food items should be place on promotion. The promotion prioritization scheme may take into account a variety of factors. By way of example, promotion prioritization criteria may be defined by a set promotion prioritization order for the identified multiple food products. Alternatively, the promotion prioritization criteria may be defined at least in part by dollar value of food product that might expire. At step 122, for each food item identified for sale promotion, a sales promotion message is retrieved for display on the scale display (e.g., the customer facing display 27) and the price of the food item on promotion is updated to reflect a reduced price (e.g., the price in the pricing database is reduced (e.g., from $5.99 per pound to $4.99 per pound) or, in the case of a pricing database that has pre-stored both the normal price and a sales promotion price, the sales promotion price is set to be the active price). By way of example, the sales promotional message may be a static message (e.g., similar to a printed sign), a video message (e.g., as in playing of a vide file on the display, or an audio-visual message (e.g., similar to a television commercial). The routine ends at step 124.

Where more than one food item is identified for sales promotion at the same time, the display may display the sales promotional messages for the items sequentially in time in a repeating loop or, alternatively, all may be displayed simultaneously. Each sales promotion message will typically identify both the food product and promotional price information for the food product. Other information may also be displayed, such as an anticipated duration of the sales promotion. The scales and/or store computer may be programmed to automatically discontinue the sales promotion when the remaining quantity of the food item is none or zero.

It is recognized that the level of the price reduction implemented as part of the sales promotion might vary depending upon just how much of the food item is remains before the expiration (e.g., the higher the remaining quantity the steeper the price reduction). In this case multiple sets of sales promotion criteria for each item may exist in order to determine the appropriate priced reduction. It is also possible that the price reduction for a given food item may be varied during the sales promotion. For example, when a sales promotion for a food item is initially implemented the price reduction may initially be set at one level based upon first sales promotion criteria being satisfied. During a later run of the sales promotion identification routine a determination may be made that the food item satisfies second sales promotion criteria that dictates an even lower price.

It is to be clearly understood that the above description is intended by way of illustration and example only and is not intended to be taken by way of limitation.

What is claimed is:

1. A method of selectively and timely promoting sale of a specific food product using a food product scale, the food product scale including a weighing station including an associated mechanism for producing weight indicative signals, a customer facing display associated with the scale, the method comprising:
entering product identification information of a specific food product into the food product scale using an operator interface of the food product scale;
identifying an initial quantity of the specific food product;
identifying expiration data for the specific food product;
creating a shelf life record that is saved in memory, the shelf life record including the product identification information, the expiration data of the specific food product and the initial quantity; and
tracking subsequent transactions for the specific food product and quantity of each subsequent transaction; and
based upon the tracking step, automatically and selectively implementing a sales promotion for the specific food product when sales promotion criteria are met, the sales promotion criteria based at least in part upon remaining quantity of the specific food product; and
when the sales promotion is implemented, displaying a sales promotional message on the customer facing display to notify customers of the sales promotion, the sales promotional message identifying both the specific food product and promotional price information for the specific food product.

2. The method of claim 1 wherein a product database is provided for use when product pricing operations are performed by the scale, and either:
(i) the product database includes a stored per unit price, and when the sales promotion is implemented the stored per unit price is automatically updated to reflect a reduction in per unit price for the specific food product; or
(ii) the product database includes both a stored normal per unit price and a stored promotional per unit price, and when the sales promotion is implemented the stored promotional per unit price is utilized for transactions for the specific food product.

3. The method of claim 1 wherein the sales promotion criteria is based at least in part upon both remaining quantity of the specific food product remaining shelf life of the specific food product.

4. The method of claim 3 wherein the sales promotion criteria includes at least that remaining quantity of the specific food product being above a set threshold and remaining shelf life of the specific food product being below a set threshold.

5. The method of claim 3 wherein the sales promotion criteria is defined by a combination of remaining quantity of the specific food product, remaining shelf life of the specific food product and historical sales data for the specific food product.

6. The method of claim 1 wherein the step of identifying expiration data involves either (i) entering expiration data via the operator interface of the food product scale or (ii) retrieving expiration data from a database.

7. The method of claim 1 wherein the step of identifying initial quantity involves either (i) entering initial quantity via the operator interface of the food product scale or (ii) retrieving initial quantity from a database.

8. The method of claim 1 wherein the shelf life record is saved in one or both of (i) memory of the food product scale or (ii) memory of a remote computer that is linked for communication with the food product scale.

9. The method of claim 1 wherein the initial quantity is either a weight or an item count.

10. The method of claim 1, including the step of:
based upon the tracking step, identifying when the specific food product is no longer available and responsively ending the sales promotion.

11. A method of selectively and timely promoting sale of a specific food product using a food product scale, the food product scale including a weighing station including an associated mechanism for producing weight indicative signals, a customer facing display associated with the scale, the method comprising:
creating and saving in memory a shelf life record for the specific food product, the shelf life record including product identification information for the specific food product, expiration data for the specific food product and initial quantity for the specific food product; and
tracking subsequent transactions for the specific food product and quantity of each subsequent transaction;
based upon the tracking step,
automatically and selectively implementing a sales promotion for the specific food product when first sales promotion criteria are met, the first sales promotion criteria based at least in part upon remaining quantity of the specific food product, when the sales promotion is implemented, displaying a first sales promotional message on the customer facing display to notify customers of the first sales promotion, the first sales promotional message identifying both the specific food product and a first promotional price for the specific food product; and
subsequently altering the sales promotion to further reduce price for the specific food product when second sales promotion criteria are met and thereafter displaying a second sales promotional message on the customer facing display, the second sales promotional message identifying both the specific food product and a second promotional price for the specific food product, the second promotional price lower than the first promotional price.

12. A method of selectively and timely promoting sale of a food products using a food product scale, the food product scale including a weighing station including an associated mechanism for producing weight indicative signals, a customer facing display associated with the scale, the method comprising:
for each of a plurality of food products, creating and saving in memory a corresponding shelf life record including product identification information, expiration data and initial quantity;
automatically tracking subsequent transactions for the multiple food products, including quantity of each subsequent transaction;
based upon the tracking step, automatically identifying impending expiration of at least one food product and automatically implementing a sales promotion for the identified food product, implementation of the sales promotion involves displaying a sales promotional message on the customer facing display to notify customers of the sales promotion, the sales promotional message identifying both the identified food product and a promotional price for the identified food product.

13. The method of claim 12 including:
based upon the tracking step, automatically identifying impending expiration of multiple food products and automatically implementing a sales promotion for less than all of the identified multiple food products based upon promotion prioritization criteria.

14. The method of claim 13 wherein the promotion prioritization criteria is defined by a set promotion prioritization order for the identified multiple food products.

15. The method of claim 13 wherein the promotion prioritization criteria is defined at least in part by dollar value of food product that might expire.
